(19) United States
(12) Patent Application Publication
(10) Pub. No.: US 2012/0041774 A1
(43) Pub. Date: Feb. 16, 2012

(54) PATIENT-SPECIFIC CLINICAL DECISION SUPPORT

(75) Inventors: MICHAEL DEAN SCHMITT, KANSAS CITY, MO (US); Brian Neuharth, Lakewood, CO (US); Rachel Hagemann, Liberty, MO (US)

(73) Assignee: CERNER INNOVATION, INC., OVERLAND PARK, KS (US)

(21) Appl. No.: 12/856,263

(22) Filed: Aug. 13, 2010

(51) Int. Cl. G06Q 50/00

(52) U.S. Cl. 705/2

(57) ABSTRACT

Patient-specific clinical decision support is provided. When drug information is received, its relevance is determined based on received clinical information. If the drug information is relevant, an alert is communicated to the clinician. The alert may be a warning or may direct the clinician to perform an action related to patient care. A user interface is generated using the received drug and clinical information. A clinician may interact with the user interface by acknowledging or responding to various alerts. Clinical decision support is provided based on the relevancy of the drug information to the patient's clinical situation.

### BACKGROUND

The modern practice of medicine poses a number of challenges for clinicians to effectively deliver quality care to patients. In particular, the effective medical knowledge base continues to grow at a rapid pace, making it difficult for clinicians to keep up with and carry out recognized best practices. For instance, thousands of new journal articles are published each month providing a plethora of new evidence-based clinical information. Additionally, new drugs, treatment techniques, and testing procedures are continuously being researched and developed. The difficulty for clinicians to keep appraised of such information is exacerbated by the fact that clinicians are typically pulled in many different directions by a vast number of patients. Moreover, clinicians must often make quick decisions regarding patient treatment. Information that is readily available is provided in general terms, without regard to actual clinical situations. As a result, there currently exists a gap between recognized best practice and actual clinician practices. This gap contributes to decreased quality of care, increased risk of medical errors, and increased cost of healthcare.

### BRIEF SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to providing clinical decision support based on a patient's clinical situation. When a clinical decision support event is triggered (either automatically or manually in various embodiments), stored clinical information available for a patient that is relevant to the clinical decision support event is accessed, and alerts are presented to a clinician only when relevant to the particular patient receiving care. The alerts include a number of clinical information elements that are relevant to the clinical decision support event for a specific patient. The stored clinical information that was accessed may be used to populate at least a portion of the clinical information elements. The clinician may acknowledge alerts or be directed perform additional actions related to patient care. Clinical advice may be provided based on both the stored clinical information and the patient's clinical situation.

### BRIEF DESCRIPTION OF THE SEVERAL VIEWS OF THE DRAWINGS

The present invention is described in detail below with reference to the attached drawing figures, wherein:

FIG. 1 is a block diagram of an exemplary computing environment suitable for use in implementing the present invention;

FIG. 2 is a block diagram of an exemplary system including a clinical decision support engine in accordance with an embodiment of the present invention;

FIG. 3 is a flow diagram showing an exemplary method for providing patient-specific clinical decision support in accordance with various embodiments of the present invention; and

FIGS. 4A-4C are illustrative screen displays showing patient-specific clinical decision support in accordance with embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different components of methods employed, the terms should not be interpreted as implying any particular order among or between various steps herein disclosed unless and except when the order of individual steps is explicitly described.

Embodiments of the present invention can positively impact health organizations' key imperatives in a variety of ways. Embodiments offer dramatic potential to improve patient safety and enable a clinician to avoid nuisance alerts, thereby greatly improving the effectiveness and clinician buy-in of medication clinical decision support (mCDS) systems. Embodiments present advantages over other decision support systems which are limited to generic alerts without regard to a patient's clinical situation.

Over the past decade, there has been an increased use of computers to assist clinicians in the clinical care process. In particular, clinical decision support systems have been developed to address the gap between evidenced best practices and actual clinician practices by assisting clinicians in the delivery of care. Generally, clinical decision support systems may provide point-of-care case-specific clinical advice based on clinical information for a patient and a clinical knowledge base.

Different types of clinical decision support systems are available that may support various aspects of the clinical care process, such as clinical diagnosis and treatment planning, thereby advancing clinicians' use of best practices. In one form, currently mCDS systems provide decision support through advice and alerts that are triggered based on stored clinical information. The primary source of mCDS is from commercially available sources, such as through products offered by First DataBank or Medispan. The content of such sources is based on public literature and information from pharmaceutical manufacturers. Unfortunately, much of the content is theoretical in nature and does not take into consideration the patient's clinical situation. Moreover, such systems do not take into account duplicate therapies, routes of administration, degrees of allergic reactions, and the like. As such, many of these alerts are not relevant for the particular patient receiving care. In addition to stopping the workflow, these alerts have become such a nuisance, they are often ignored. It is estimated that 60-92% of alerts are ignored, or in some cases, turned off completely by clinicians.

Accordingly, in one aspect, an embodiment of the present invention is directed to a method in a clinical computing environment for providing clinical decision support based on a patient's clinical situation. The method includes receiving drug information associated with at least one drug administered to a patient. The method also includes receiving clinical information specific to the patient's clinical situation. Relevancy of the drug information to the patient is determined based on the clinical information. The method further includes presenting alerts to a clinician if it is determined that the drug information is relevant.

In another aspect of the invention, an embodiment is directed to a graphical user interface (GUI). The GUI comprises a first display area configured for displaying drug information associated with at least one drug being administered to patient. The GUI further comprises a second display area configured for displaying clinical information associated with the patient's clinical situation. A third display area is configured for displaying alerts to a clinician based upon the relevancy of the drug information to the clinical situation.

In a further aspect, an embodiment is directed to system environment for providing clinical decision support based on a patient's clinical situation. The system includes a display device receiving data from a server comprising at least one component. The system also includes a drug information component for receiving drug information associated with at least one drug administered to a patient. The system further includes a clinical information component for receiving clinical information specific to the patient's clinical situation. A determination component determines if the drug information is relevant to the clinical situation and an alerting component alerts a clinician if the drug information is relevant to the clinical situation.

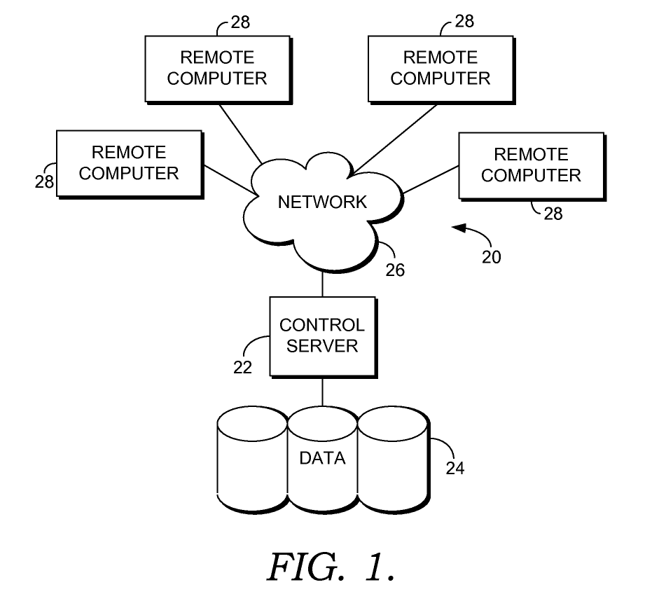

Referring now to the drawings in general, and initially to FIG. 1 in particular, an exemplary computing system environment, for instance, a medical information computing system, on which embodiments of the present invention may be implemented is illustrated and designated generally as reference numeral 20. It will be understood and appreciated by those of ordinary skill in the art that the illustrated medical information computing system environment 20 is merely an example of one suitable computing environment and is not intended to suggest any limitation as to the scope of use or functionality of the invention. Neither should the medical information computing system environment 20 be interpreted as having any dependency or requirement relating to any single component or combination of components illustrated therein.

Embodiments of the present invention may be operational with numerous other general purpose or special purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

Embodiments of the present invention may be described in the general context of computer-executable instructions, such as program modules, being executed by a computer. Generally, program modules include, but are not limited to, routines, programs, objects, components, and data structures that perform particular tasks or implement particular abstract data types. Embodiments of the present invention may also be practiced in distributed computing environments where tasks are performed by remote processing devices that are linked through a communications network. In a distributed computing environment, program modules may be located in local and/or remote computer storage media including, by way of example only, memory storage devices.

With continued reference to FIG. 1, the exemplary medical information computing system environment 20 includes a general purpose computing device in the form of a server 22. Components of the server 22 may include, without limitation, a processing unit, internal system memory, and a suitable system bus for coupling various system components, including database cluster 24, with the server 22. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The server 22 typically includes, or has access to, a variety of computer readable media, for instance, database cluster 24. Computer readable media can be any available media that may be accessed by server 22, and includes volatile and nonvolatile media, as well as removable and non-removable media. By way of example, and not limitation, computer readable media may include computer storage media and communication media. Computer storage media may include, without limitation, volatile and nonvolatile media, as well as removable and nonremovable media implemented in any method or technology for storage of information, such as computer readable instructions, data structures, program modules, or other data. In this regard, computer storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the server 22. Communication media typically embodies computer readable instructions, data structures, program modules, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer readable media.

The computer storage media discussed above and illustrated in FIG. 1, including database cluster 24, provide storage of computer readable instructions, data structures, program modules, and other data for the server 22.

The server 22 may operate in a computer network 26 using logical connections to one or more remote computers 28. Remote computers 28 may be located at a variety of locations in a medical or research environment, for example, but not limited to, clinical laboratories, hospitals and other inpatient settings, veterinary environments, ambulatory settings, medical billing and financial offices, hospital administration settings, home health care environments, and clinicians' offices. Clinicians may include, but are not limited to, a treating physician or physicians, specialists such as surgeons, radiologists, cardiologists, and oncologists, emergency medical technicians, physicians' assistants, nurse practitioners, nurses, nurses' aides, pharmacists, dieticians, microbiologists, laboratory experts, genetic counselors, researchers, veterinarians, students, and the like. The remote computers 28 may also be physically located in non-traditional medical care environments so that the entire health care community may be capable of integration on the network. The remote computers 28 may be personal computers, servers, routers, network PCs, peer devices, other common network nodes, or the like, and may include some or all of the components described above in relation to the server 22. The devices can be personal digital assistants or other like devices.

Exemplary computer networks 26 may include, without limitation, local area networks (LANs) and/or wide area networks (WANs). Such networking environments are commonplace in offices, enterprise-wide computer networks, intranets, and the Internet. When utilized in a WAN networking environment, the server 22 may include a modem or other means for establishing communications over the WAN, such as the Internet. In a networked environment, program modules or portions thereof may be stored in the server 22, in the database cluster 24, or on any of the remote computers 28. For example, and not by way of limitation, various application programs may reside on the memory associated with any one or more of the remote computers 28. It will be appreciated by those of ordinary skill in the art that the network connections shown are exemplary and other means of establishing a communications link between the computers (e.g., server 22 and remote computers 28) may be utilized.

In operation, a user may enter commands and information into the server 22 or convey the commands and information to the server 22 via one or more of the remote computers 28 through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote healthcare device to the server 22. In addition to a monitor, the server 22 and/or remote computers 28 may include other peripheral output devices, such as speakers and a printer.

Although many other internal components of the server 22 and the remote computers 28 are not shown, those of ordinary skill in the art will appreciate that such components and their interconnections are well known. Accordingly, additional details concerning the internal construction of the server 22 and the remote computers 28 are not further disclosed herein.

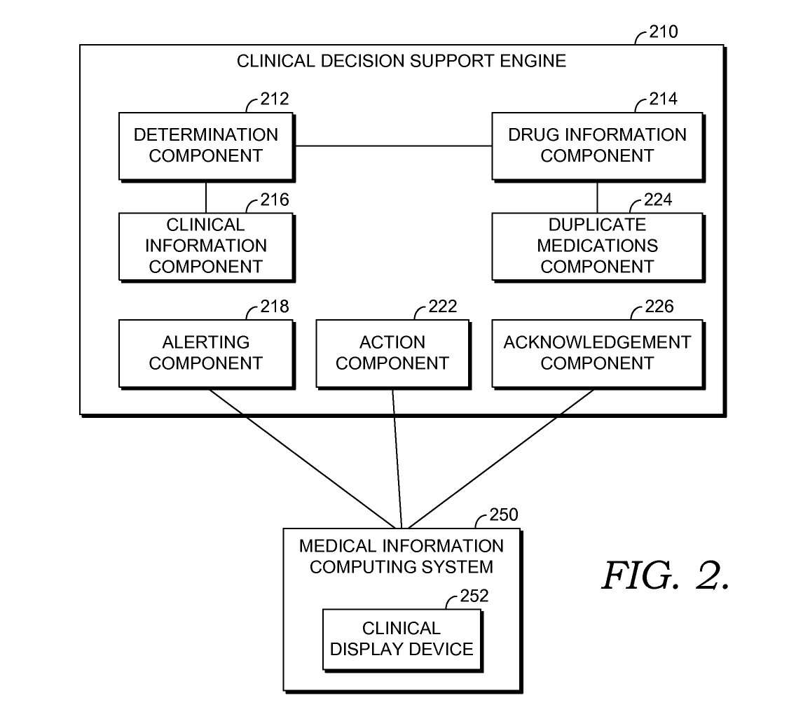

Referring now to FIG. 2, a block diagram is provided illustrating an exemplary system 200 in which a clinical decision support engine 210 is shown interfaced with a medical information computing system 250 in accordance with an embodiment of the present invention. The medical information computing system 250 may be a comprehensive computing system within a clinical environment similar to the exemplary computing system 20 discussed above with reference to FIG. 1.

The medical information computing system 250 includes a clinical display device 252. In one embodiment, the clinical display device 252 is configured to display alerts received from the clinical decision support engine 210. In another embodiment, the clinical display device is configured to receive input from the clinician, such as medication orders, laboratory orders, and the like.

The clinical decision support engine 210 is generally configured to provide clinical decision support events to provide clinical advice to clinicians. As shown in FIG. 2, the clinical decision support engine may include a determination component 212, a drug information component 214, a clinical information component 216, and an alerting component 218. In various embodiments, the clinical decision support engine may also include an action component 222, a duplicate medications component 224, and an acknowledgement component 226.

Drug information received by the drug information component 214 and clinical information received by the clinical information component 216 are shared with the determination component 212 to determine the relevancy of the drug information in view of the patient's clinical situation as evidenced by the clinical information. Drug information includes drug/drug interactions, drug/food interactions, duplicate therapy indications, medication clinical text, dose range indications, IV compatibility indications, allergy interactions, drug/disease interactions, and disease/drug recommendations. Clinical information includes vital signs, height, weight, laboratory results, dosages, diseases, allergies/degrees of allergies (e.g. rash or difficulty breathing), diet information, and other information that may affect the relevancy of the drug information for a particular patient.

In one example, the drug information may indicate an interaction between an angiotensin-converting enzyme (ACE) inhibitor, such as captopril, and a potassium sparing diuretic, such as spironolactone. Previously, if a patient were being treated with both captopril and spironolactone, an alert would generally be triggered. However, a patient's clinical situation does not always warrant such an alert. In embodiments of the invention, the clinician only needs to be alerted to the interaction if the patient's potassium level is elevated. In this case, if the clinical information component 216 receives laboratory results indicating that the patient's potassium level is elevated, then the determination component 212 determines that, based on the elevated potassium level, the interaction between captopril and spironolactone is relevant to the patient's clinical situation and an alert is provided by the alerting component 218. In another embodiment, if the clinical information component 216 receives laboratory results indicating that the patient's potassium level is not elevated, then the determination component 212 determines that the interaction between captopril and spironolactone is not relevant to the patient's clinical situation, and no alert is provided by the alerting component 218. By leveraging laboratory results in this manner, the relevancy of drug interactions can be determined beyond mere drug-drug interactions. That is, rather than the alerting component 218 sending an alert as spironolactone is ordered for any patient already receiving captopril, the clinical information component 216 receives potassium levels on a continuing basis. Furthermore, this prevents unnecessary alerts for a situation where a clinician orders spironolactone for a patient already receiving captopril, where the patient is never actually administered the spironolactone. Leveraging patient laboratory results makes the drug interaction process specific to the particular patient.

In another example, patient clinical information such as diet may be relevant to drug information. For instance, an alert based on drug information received by the drug information component 214 is not generally necessary if the patient is receiving oral hypoglycemic. However, if the clinical information component 216 also receives information indicating the patient is on an American Dietetic Association (ADA) diet, then the determination component 212 determines the drug information relevant.

In another example, drug information may be relevant to a particular patient based on routes of administration. For instance, an antacid therapy may have an interaction with ciprofloxacin, depending on the route of administration of the ciprofloxacin. Rather than inundating a clinician with alerts simply because the patient is receiving ciprofloxacin, the determination component 212 determines based on the information (e.g. routes of administration of two drugs) received from the clinical information component 216 whether an interaction actually exists. In this example, an interaction between ciprofloxacin given intravenously and antacids to a particular patient does not exist. However, if the ciprofloxacin is given orally, then the determination component 212 determines that the aluminum, magnesium, or calcium in the antacids binds to the ciprofloxacin and the clinician is alerted by alerting component 218.

In yet another example, certain medications may cause allergic reactions in patients. Typically, the clinical information for the patient does not reflect specific degrees associated with the allergic reactions. For example, a drug may inhibit a patient's ability to breath. Or, the drug may cause a rash or watery eyes. Or, the drug may only cause a minor side effect, such as an upset stomach. Seven types of allergy reactions are typically recognized. Rather, than discouraging use of that particular drug altogether, the determination component 212 may determine, based upon patient-specific information received by the clinical information component 216, the relevancy of the allergy warnings associated with the drug. If the clinical information indicates a patient merely suffers an upset stomach, the determination component 212 may determine that the drug information is not relevant based upon the clinical situation.

Similarly, cephalosporins are often given to patients with allergies to penicillins. However, approximately 10-20% of patients allergic to penicillin also exhibit an allergic reaction to cephalosporins. Even though 80-90% of patients do not possess this allergy, clinicians are ordinarily alerted because the literature indicates an allergy may exist. However, the determination component 212, in embodiments of the present invention, only determines that such drug information is relevant if the clinical information actually indicates the patient is allergic, in this example, to cephalosporins. As such, clinicians are only discouraged from using drug alternatives if the clinical situation dictates that course of action.

If the drug information is determined by the determination component 212 to be relevant to the patient's clinical situation (as in the example above), the drug information is shared with the alerting component 218. The alerting component 218 presents the drug information in the form of an alert to the medical information computing system 250 where it is presented to the clinician via a clinical display device 252. Referring to the first example above, the clinician would be alerted to the interaction between captopril and spironolactone.

In one embodiment, an action component 222 directs the clinician to perform an action related to patient care based on the alert. Such an action may direct the clinician to perform a certain laboratory procedure on the patient in response to the alert, or may direct the clinician to administer an additional medication or treatment for the patient. As such, the alerting component 218 can greatly reduce time and effort associated with the clinical decision making process.

In another embodiment, an acknowledgement component 224 receives input from the clinician via the medical information computing system such that additional alerts related to the same piece of information are no longer provided. Such an acknowledgement may be useful to avoid a situation where multiple clinicians in multiple departments are treating the same patient. It is impractical and inefficient for every clinician to be alerted with the same information. The acknowledgment component 224 avoids this redundancy of alerts and prevents the stoppage of workflow that otherwise results. As such, the acknowledgement component 224 allows the first acknowledging clinician to effectively acknowledge the alert for each treating clinician. The acknowledgment component 224 further allows a clinician to acknowledge an interaction exists by encounter. Suppose a clinician orders medications given together for a clinical purpose that may otherwise cause an alert. For example, clopidrogel and aspirin may be administered to a cardiac patient. Typically, this would cause the determination component 212 to determine that an interaction existed and the clinician would be alerted. However, because the clinician wants to proceed without being alerted, the clinician may acknowledge the alert and proceed.

In yet another embodiment, a duplicate medications component 226 works with the determination component 212 to consider medications that are often given together for clinical reasons. For example, a clinician may order Tylenol, Tylenol with codeine, or Vicodin for various degrees of pain. In another example, a clinician may treat a patient with various forms of insulin. It is not uncommon for a patient to receive more than one of the above medications or treatments for clinical reasons. Typically, this results in multiple alerts and becomes a nuisance. However, the duplicate medications component 224 recognizes common therapies such as these and avoids a simple chemical identification check. Rather, the duplicate medications component 226, upon receiving drug information from the drug information component 214 that multiple medications are being administered to a patient with the same chemical identification, communicates to the determination component 212 that the drug some information is not relevant and an alert should not be issued. The duplicate medications component 226 is configurable to allow a clinician to set a threshold amount for certain medications before being alerted by alerting component 218 according to the clinician's preference.

Although the clinical decision support engine 210 is shown in FIG. 2 as being interfaced with the medical information computing system 250, one skilled in the art will recognize that in embodiments, the clinical decision support engine 210 may be integrated into the medical information computing system 250. In other embodiments, the clinical decision support engine 210 may simply be interfaced with data stores containing clinical and drug information independent of a comprehensive medical information computing system 250. However, by interfacing and/or integrating the clinical decision support engine with a comprehensive medical information computing system, such as the medical information computing system of FIG. 2, a number of advantages may be realized. For example, the medical information computing system 250 may be interfaced with or otherwise include computing devices and/or computing systems in a variety of different clinical domains within a healthcare environment. By way of example only and not limitation, the medical information computing system 250 may include a clinical laboratory system, a pharmacy system, a radiology system, and a hospital administration system. Accordingly, the medical information computing system 250 provides a unified computing architecture that is able to access and aggregate clinical and drug information from a variety of different sources and make the clinical and drug information available to the clinical decision support engine. In an embodiment, the medical information computing system 250 may store clinical and drug information from different sources in a patient-centric electronic medical record.

Another advantage of interfacing and/or integrating the clinical decision support engine 210 with the medical information computing system 250 is that clinical decision support may be provided at the point-of-care via a remote computer. For instance, the medical information computing system 250 may include a number of remote computers, such as the remote computers 28 of FIG. 1. The remote computers may be located at, for example, patients' bedsides, nurses' stations, and physicians' offices. Accordingly, clinicians may be able to access the clinical decision support engine via a remote computer of the medical information computing system, such that clinical decision support may be provided at the point-of-care.

A further advantage of interfacing and/or integrating the clinical decision support engine 210 with the medical information computing system 250 is that information associated with a decision support event may be captured and stored by the medical information computing system 250 with other clinical information, such as, for instance, in a patient's electronic medical record. For example, information that may be captured from a clinical decision support event may include clinical information entered by a clinician during the clinical decision support event, clinical advice determined during the decision support event, and any orders entered based on the decision support event.

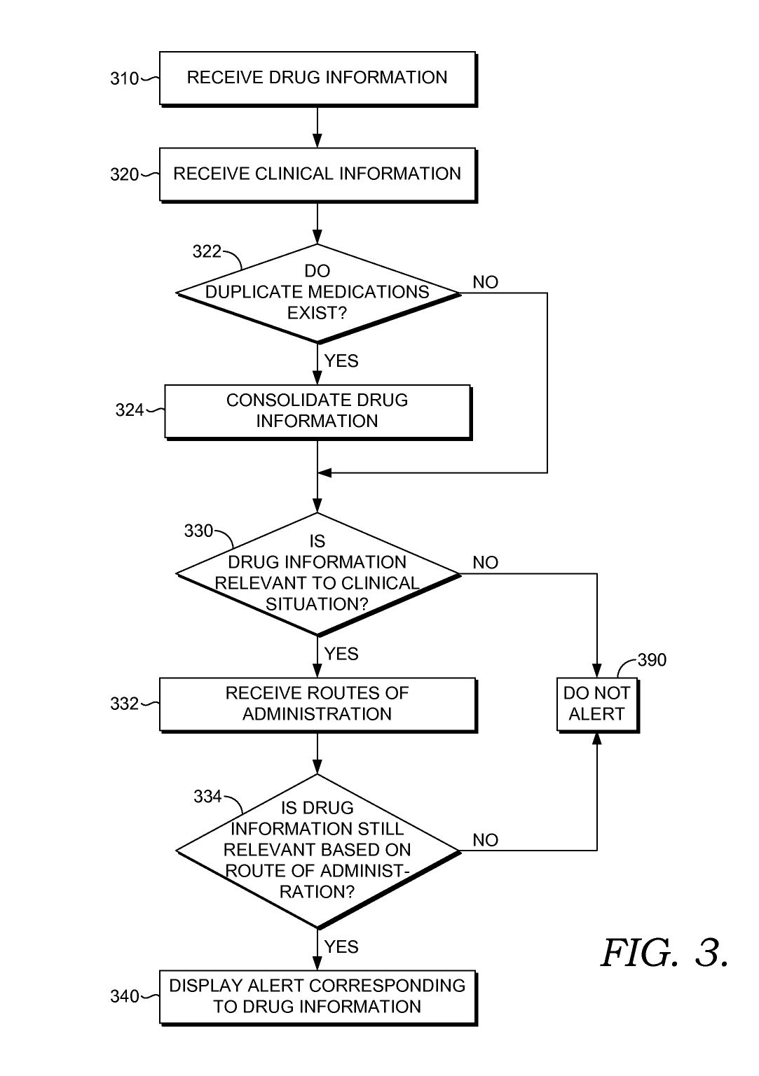

Turning now to FIG. 3, a flow diagram is provided illustrating a method 300 for providing patient-specific clinical decision support in accordance with an embodiment of the present invention. Initially, as shown at block 310, drug information associated with at least one drug administered to a patient is received. Drug information, as used herein, refers to content based upon public literature and information from pharmaceutical manufacturers from commercially available sources, such as Multum. The drug information at this point is general in its terms and may describe interactions or allergies that only affect, for example, 10% of the population. As such, the drug information in this example is not useful or applicable for the remaining 90% of the population. At block 320, clinical information specific to the patient's clinical situation is received.

At block 330, the patient information is considered to determine if the drug information is relevant to the patient's clinical situation. If the drug information is relevant, as described in multiple examples above, an alert is displayed at block 340 that corresponds to the relevant drug information. If the drug information is not relevant, no alerts are displayed, as shown at block 340, for that portion of the drug information that is not relevant. An alert may describe, in one embodiment, an interaction between one medication that is being ordered and another medication that is being ordered or has already been administered to the patient. In another embodiment, an alert may describe an interaction between the patient's diet and an ordered medication. Similarly, in another embodiment, an alert may describe an interaction between the patient's condition, such as a disease, and an ordered medication. In yet another embodiment, an alert may describe an allergy associated with the ordered medication. The alert may also, in another embodiment, direct the clinician to perform an action related to patient care. Such an action may include ordering another medication, ordering a laboratory procedure, checking vital signs or other characteristics of the patient, and the like.

Referring again to FIG. 3, in another embodiment, as shown at block 322, duplicate medications may exist within the received drug information. If it is determined that duplicate medications exist, the drug information associated with the duplicate medications is consolidated into a single instance of the drug information at block 324. This embodiment prevents a clinician from receiving multiple alerts for the same drug information that can exacerbate the nuisance problem described above.

Referring again to FIG. 3, in another embodiment, it may be necessary, after drug information is determined to be relevant, to consider the route of administration. At block 332, the route of drug administration is received. It is then determined, at block 334, if the drug information is still relevant in view of the route of administration. If the drug information is still relevant to the patient's clinical situation, considering the route of administration, then the alert is displayed at block 340, as described above. If it is not, then no alert is provided, as shown at block 390.

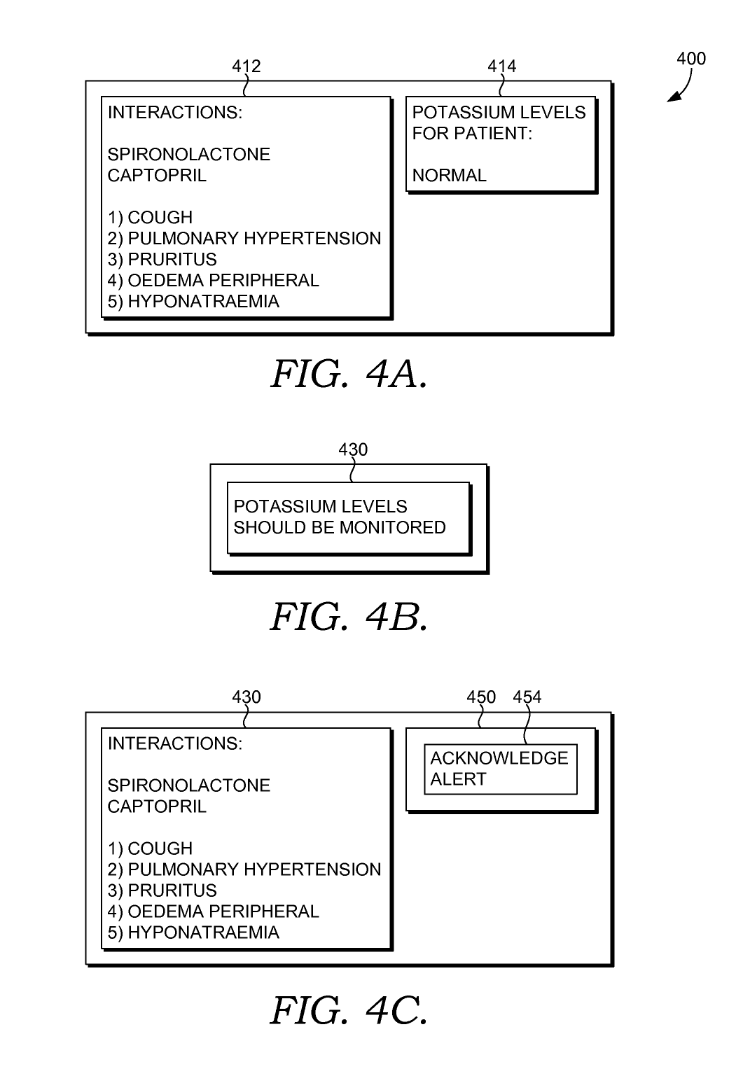

Referring now to FIG. 4A, an illustrative graphical user interface 400 is shown in accordance with an embodiment of the present invention. A first display area 412 identifies drug information and a second display area 414 identifies information related to the patient's clinical situation. For example, assume a clinician orders spironolactone for a patient already on captopril. In this example, the first display area 412 indicates that possible interactions for captopril and spironolactone exist and may include: 1) Cough; 2) Pulmonary Hypertension; 3) Pruritus; 4) Oedema Peripheral; and 5) Hyponataemia. However, the second display area 414 indicates that the patient's potassium level is normal. In this example, the drug information is not relevant for this patient.

Referring now to FIG. 4B, a third display area 430 displays alerts if the drug information is relevant to the patient's clinical situation. In the present example, no alert is displayed indicating an interaction between captopril and spironolactone (not shown). However, an alert (as shown by FIG. 4B) may be displayed in the third display area 430 indicating that potassium levels should be monitored on a continuing basis after the spironolactone is added to the patient's medication therapy.

Referring now to FIG. 4C, if the patient's potassium levels become elevated, a third display area 430 displays the drug-drug interaction. A fourth display area 450 displays an area for the clinician to acknowledge the alert. After the clinician acknowledges the alert, such as by pressing the “Acknowledge Alert” button 454, that particular alert is no longer displayed. Such a feature prevents multiple departments across the same or multiple health care facilities from receiving identical alerts.

As can be understood, the present invention provides systems, methods, and user interfaces for providing clinical decision support based on a patient's clinical situation. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated and within the scope of the claims.

1. One or more computer storage media having computer-executable instructions embodied thereon, that when executed, perform a method for providing medication clinical decision support, the method comprising:
receiving drug information associated with at least one drug ordered, dispensed, or administered to a patient;
receiving laboratory results for the patient;
determining if the drug information is relevant based on the laboratory results for the patient; and
displaying alerts to a clinician if the drug information is relevant.

2. The media of claim 1, further comprising determining if duplicate medications exist within the received drug information.

3. The media of claim 2, further comprising consolidating alerts for the duplicate medications into a single alert.

4. The media of claim 1, further comprising receiving routes of drug administration.

5. The media of claim 4, further comprising determining if the drug information is relevant based on the routes of administration.

6. The media of claim 1, further comprising receiving an acknowledgement of an alert from the clinician.

7. The media of claim 6, further comprising preventing further associated alerts after the acknowledgment is received.

8. The media of claim 1, wherein the drug information comprises drug/drug interactions, drug/food interactions, duplicate therapy-checking, medication clinical reference text, dose range checking, IV compatibility compatibility-checking, allergy checking, drug/disease checking, and disease/drug recommendations.

9. The media of claim 1, wherein the alerts direct the clinician to perform an action related to patient care.

10. One or more computer storage media having computer-executable instructions embodied thereon, that when executed, perform a method for providing medication clinical decision support, the method comprising:
receiving drug information associated with a first drug ordered, dispensed, or administered to a patient;
receiving drug information associated with a second drug ordered, dispensed, or administered to the patient;
receiving clinical information specific to the patient's clinical situation, wherein clinical information includes the routes of administration for the first and second drugs;
determining if the drug information is relevant to the patient based on the routes of administration; and
displaying alerts to a clinician if the drug information is relevant.

11. The media of claim 10, wherein the clinical information includes laboratory results.

12. The media of claim 11, further comprising determining if the drug information is relevant to the patient based on the laboratory results.

13. The media of claim 10, wherein the drug information comprises drug/drug interactions, drug/food interactions, duplicate therapy-checking, medication clinical reference text, dose range checking, IV compatibility compatibility-checking, allergy checking, drug/disease checking, and disease/drug recommendations.

14. A computerized system for providing medication clinical decision support, the system comprising:
a display device receiving data from a server comprising at least one component;
a drug information component for receiving drug information associated with at least one drug ordered, dispensed, or administered to a patient;
a clinical information component for receiving laboratory results associated with the patient;
a determination component for determining if the drug information based on the laboratory results; and
an alerting component for alerting a clinician if the drug information is relevant.

15. The system of claim 14, further comprising a duplicate medications component for determining if duplicate medications exist within the received drug information.

16. The system of claim 15, wherein the duplicate medications component consolidates alerts for the duplicate medications into a single alert.

17. The system of claim 14, wherein the clinical information includes routes of drug administration.

18. The system of claim 14, further comprising an acknowledgment component for acknowledging an alert, wherein acknowledging an alert prevents further associated alerts from occurring after the acknowledgment is received.

19. The system of claim 14, wherein the drug information comprises drug/drug interactions, drug/food interactions, duplicate therapy-checking, medication clinical reference text, dose range checking, IV compatibility compatibility-checking, allergy checking, drug/disease checking, and disease/drug recommendations.

20. The system of claim 14, further comprising an action component for directing the clinician to perform an action related to patient care based on an alert.
